(19) United States
(12) Patent Application Publication
(10) Pub. No.: US 2014/0372879 A1
(43) Pub. Date: Dec. 18, 2014

(54) RECORDING MEDIUM, DOCUMENT PROCESSING DEVICE, AND DOCUMENT PROCESSING SYSTEM

(71) Applicant: KYOCERA DOCUMENT SOLUTIONS INC., Osaka (JP)

(72) Inventors: Satoshi KAWAKAMI, Osaka (JP); Wataru ENDO, Osaka (JP); Masato TANBA, Osaka (JP); Yosuke NAKAZATO, Osaka (JP); Yoshitaka MATSUKI, Osaka (JP)

(73) Assignee: KYOCERA DOCUMENT SOLUTIONS, INC., Osaka (JP)

(21) Appl. No.: 14/302,694

(22) Filed: Jun. 12, 2014

(30) Foreign Application Priority Data
Jun. 17, 2013 (JP) 2013-127059

(51) Int. Cl. G06F 17/24

(52) U.S. Cl. CPC G06F 17/24
USPC 715/256

(57) ABSTRACT

A non-transitory computer readable recording medium stores a document processing program executed by a computer. The document processing program includes: a first program code configured to cause the computer to register a term with it bearing corresponding recognizability information indicative of a reader type to which readers capable of recognizing the term belong and a reader type to which readers incapable of recognizing the term belong; a second program code configured to cause the computer to receive specification of a reader type to which a reader belongs; a third program code configured to cause the computer to detect any term non-recognizable to the readers belonging to the reader type based on the specification from an output target document based on the recognizability information; and a fourth program code configured to cause the computer to issue a warning when the term is detected through the third program code.

### INCORPORATION BY REFERENCE

The present application claims priority under 35 U.S.C. §119 to Japanese Patent Application No. 2013-127059, filed Jun. 17, 2013. The contents of this application are incorporated herein by reference in their entirety.

### BACKGROUND

The present disclosure relates to non-transitory computer readable recording mediums that store a document processing program, document processing devices, and document processing systems.

Documents may include a term non-recognizable to readers. In this case, it is probable that the readers may insufficiently understand the content of a document. For this reason, it is preferable that the document include only terms that are recognizable to the readers. In view of this, programs that support document proofreading have been developed to create a document including only terms recognizable to the readers. For example, a typical program supports document proofreading by indicating a warning message on a display section when a document includes any term non-recognizable to the readers.

### SUMMARY

A non-transitory computer readable recording medium according to an embodiment of the present disclosure stores a document processing program executed by a computer. The document processing program includes first to fourth program codes. The first program code is configured to cause the computer to register a term with it baring corresponding recognizability information indicative of a reader type to which readers capable of recognizing the term belong and a reader type to which readers incapable of recognizing the term belong. The second program is configured to cause the computer to receive specification of a reader type to which a reader belongs. The third program code is configured to cause the computer to detect any term non-recognizable to the readers belonging to the reader type based on the specification from an output target document based on the recognizability information. The fourth program code is configured to cause the computer to issue a warning when the term is detected through the third program code.

A document processing device according to an embodiment of the present disclosure includes a term registering section, a reader type receiving section, a term detecting section, and a warning section. The term registering section is configured to register a term with it bearing corresponding recognizability information indicative of a reader type to which readers capable of recognizing the term belong and a reader type to which readers incapable of recognizing the term belong. The reader type receiving section is configured to receive specification of a reader type to which a reader belongs. The term detecting section is configured to detect any term non-recognizable to the readers belonging to the reader type based on the specification from an output target document based on the recognizability information. The warning section is configured to issue a warning when the term detecting section detects the term.

A document processing system according to an embodiment of the present disclosure includes a document processing device configured to output a document and an electronic device. The document processing device is connected to the electronic device through a network. The document processing system further includes a term registering section, a reader type receiving section, a term detecting section, and a warning section, all of which are provided on one of the document processing device and the electronic device, or are provided on the document processing device and the electronic device in a distributed manner. The term registering section is configured execute processing for registering a term with it bearing corresponding recognizability information indicative of a reader type to which readers capable of recognizing the term belong and a reader type to which readers incapable of recognizing the term belong. The reader type receiving section is configured to execute processing for receiving specification of a reader type to which a reader belongs. The term detecting section is configured to execute processing for detecting any term non-recognizable to the readers belonging to the reader type based on the specification from an output target document based on the recognizability information. The warning section is configured to execute processing for issuing a warning when the term detecting section detects the term.

### BRIEF DESCRIPTION OF THE DRAWINGS

FIG. 1 shows a configuration of a document processing system according to an embodiment.

FIG. 2 shows a configuration of a MFP according to the embodiment.

FIG. 3 shows a configuration of a management server according to the embodiment.

FIG. 4 shows an example of a term registration database according to the embodiment.

FIG. 5 shows a configuration of a PC according to the embodiment.

FIG. 6 depicts an operation of the MFP in term registration according to the embodiment.

FIG. 7 shows an example of an editing screen according to the embodiment.

FIG. 8 depicts an operation of the MFP in reader type setting according to the embodiment.

FIG. 9 shows an example of a reader type receiving screen according to the embodiment.

FIG. 10 depicts an operation of the MFP in document output.

FIG. 11 shows an example of a warning screen according to the embodiment.

FIG. 12 shows an example of a warning detail screen according to the embodiment.

### DETAILED DESCRIPTION

Embodiments of the present disclosure will be described below with reference to the accompanying drawings.

First of all, a configuration of a document processing system 10 according to the present embodiment will be described.

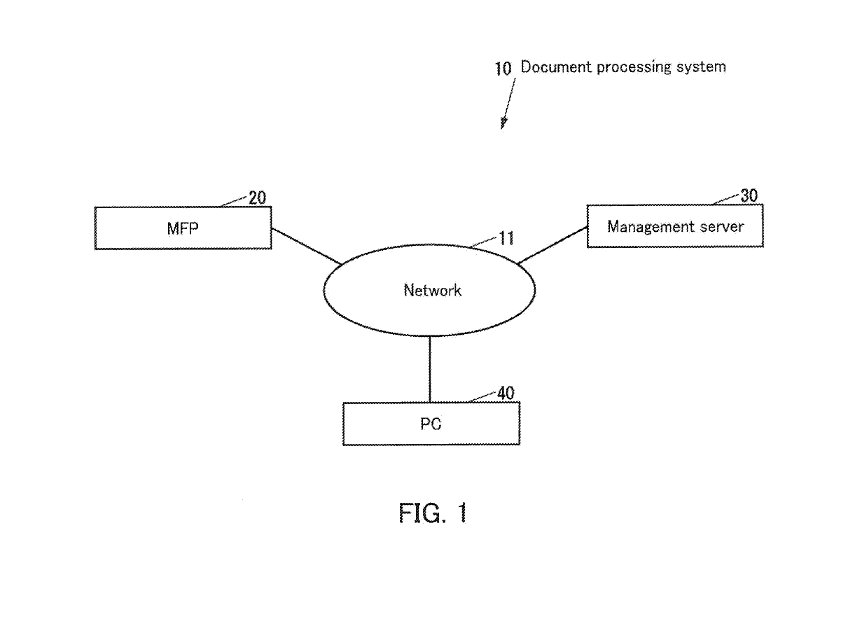

FIG. 1 shows the configuration of the document processing system 10 according to the embodiment.

As shown in FIG. 1, the document processing system 10 includes a multifunction peripheral (MFP) 20, a management server 30, and a personal computer (PC) 40. The MFP 20 is an example of a document processing device. The management server 30 is a computer that manages the MFP 20. The PC 40 is capable of transmitting print data to the MFP 20. The MFP 20 and the management server 30 are connected together through a network 11 in a communicable manner. The network 11 may be a local area network (LAN), Internet, or the like. Similarly, the MFP 20 and the PC 40 are connected together through the network 11 in a communicable manner.

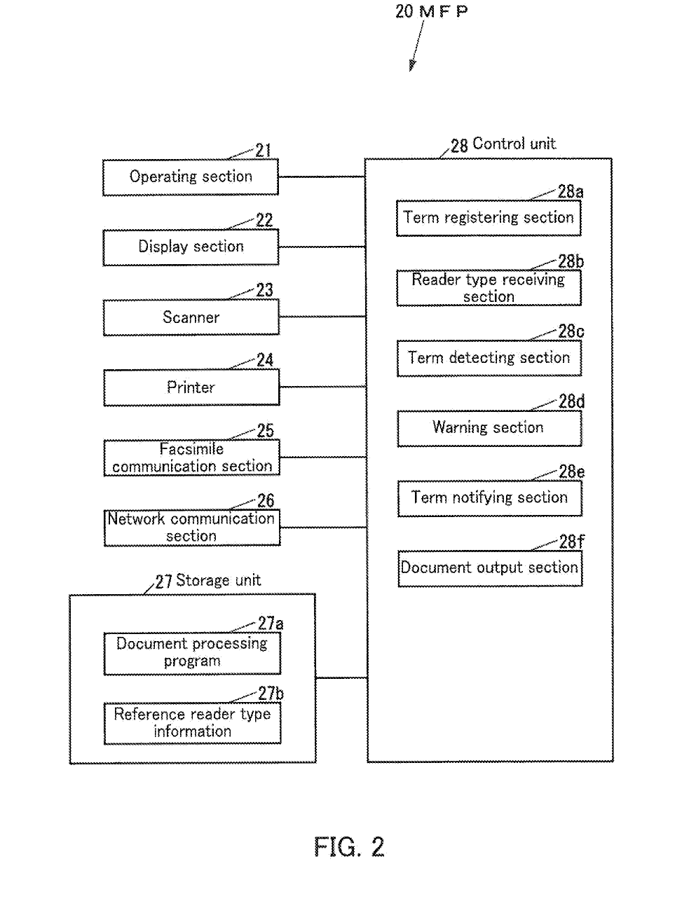

FIG. 2 shows a configuration of the MFP 20.

As shown in FIG. 2, the MFP 20 includes an operating section 21, a display section 22, a scanner 23, a printer 24, a facsimile communication section 25, a network communication section 26, a storage unit 27, and a control unit 28. The operating section 21 may be an input device, such as a button set. The user can manipulate the operating section 21 to cause the MFP 20 to execute various processing. The display section 22 may be a device that displays a variety of information. The display section 22 may be a liquid crystal display (LCD) or the like, for example. The scanner 23 is an example of a reading device that reads an image from an original document. The printer 24 is an example of a device that executes printing on a recording medium, such as paper. The facsimile communication section 25 may be a device that performs facsimile communication with an external facsimile device not shown via a communication line, such as a public telephone line. The network communication section 26 may be a device that communicates with an external device (electronic device) via the network 11 (see FIG. 1). The storage unit 27 is a device that stores various types of data. A nonvolatile memory may be used as the storage unit 27, such as an electrically erasable programmable read only memory (EEPROM), hard disk drive (HDD), etc. The control unit 28 controls the operation of the MFP 20.

The operating section 21 may include a touch panel. Alternatively, the operating section 21 itself may be a touch panel. The touch panel may be formed on the display section 22.

The storage unit 27 stores a document processing program 27a for processing a document. The document processing program 27a may be installed in the MFP 20 at manufacturing stage of the MFP 20. Alternatively, the document processing program 27a may be installed in the MFP 20 through a storage medium, such as a universal serial bus (USB) memory, an SD memory card, etc. Or, the document processing program 27a may be installed in the MFP 20 through the network 11.

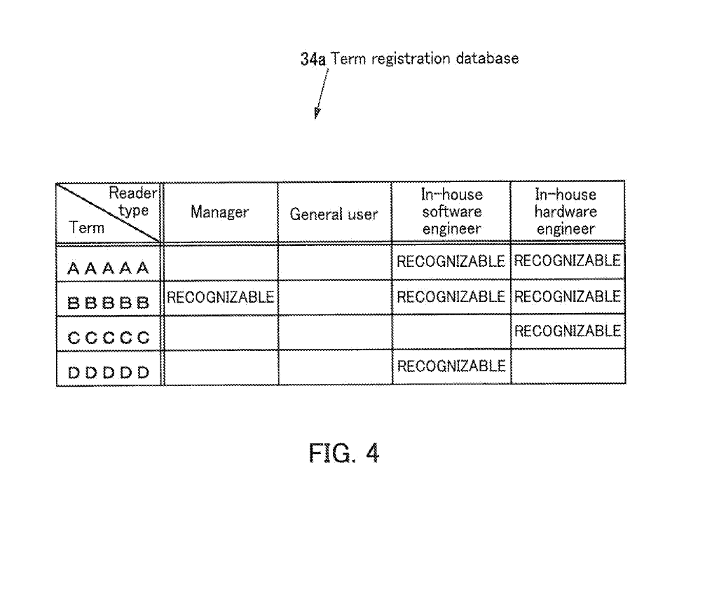

The storage unit 27 stores reference reader type information 27b. The reference reader type information 27b is information indicative of a single type specified from types to which document readers belong. The reference reader type information 27b serves as a reference in processing by the control unit 28. It is noted that although the present embodiment describes the case where a plurality of reader types are registered (or set) in a term registration database 34a that will be described later with reference to FIG. 4, this should not be taken to limit the present disclosure. Only one reader type may be registered (or set) in the term registration database 34a.

The control unit 28 includes a central processing unit (CPU), a read only memory (ROM), and a random access memory (RAM), for example. The ROM stores a program and various types of data. The RAM is used as a work area for the CPU. The CPU executes a program stored in the ROM or the storage unit 27.

The MFP 20 serves as a computer that executes the document processing program 27a stored in the storage unit 27.

The control unit 28 executes the document processing program 27a stored in the storage unit 27 to function as a term registering section 28a, a reader type receiving section 28b, and a term detecting section 28c. The term registering section 28a executes processing for registering a term with it bearing recognizability information corresponding to the term. The recognizability information is information indicative of each reader type to which readers capable of recognizing a term being registered belong and each reader type to which readers incapable of recognizing the term belong. The recognizability information may indicate the absence of a reader type to which readers capable of recognizing a term being registered belong. The reader type receiving section 28b executes processing for receiving specification of a reader type. The reference reader type information 27b is information indicative of a reader type that the reader type receiving section 28b receives. The term detecting section 28c executes processing for detecting any term non-recognizable to readers belonging to a reader type of which specification is received by the reader type receiving section 28b from an output target document (including print target) based on the recognizability information. Further, the control unit 28 executes the document processing program 27a stored in the storage unit 27 to function as a warning section 28d, a term notifying section 28e, and a document output section 28f. When the term detecting section 28c detects a term, the warning section 28d executes processing for issuing a warning. The term notifying section 28e executes processing for notifying a term that the term detecting section 28c detects. The document output section 28f executes processing for document output. Document output includes document printing.

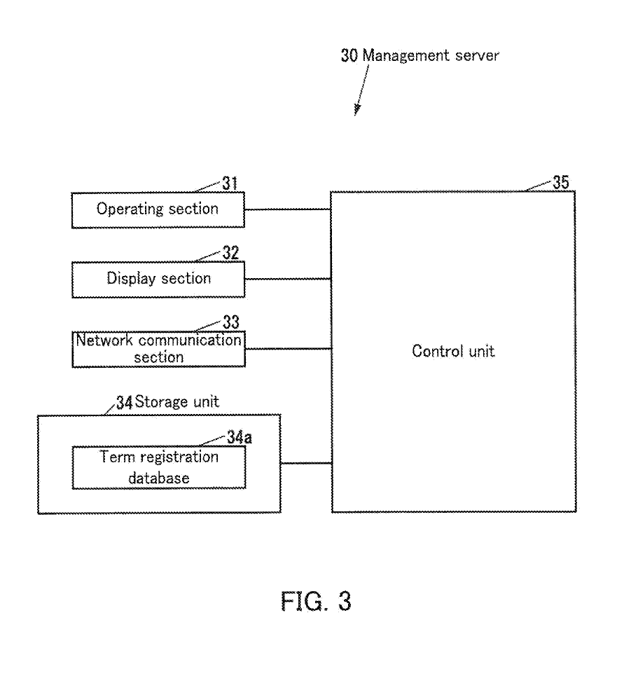

FIG. 3 shows a configuration of the management server 30.

As shown in FIG. 3, the management server 30 includes an operating section 31, a display section 32, a network communication section 33, a storage unit 34, and a control unit 35. The operating section 31 may be an input device, such as a mouse, a keyboard, or the like. The user can manipulate the operating section 31 to cause the management server 30 to execute various processing. The display section 32 may be a device that displays a variety of information. The display section 32 may be a liquid crystal display (LCD) or the like, for example. The network communication section 33 may be a device that communicates with an external device (electronic device) via the network 11 (see FIG. 1). The storage unit 34 may be a device that stores a program and various types of data. A nonvolatile memory, such as a HDD may be used as the storage unit 34. The control unit 35 may be a processor that controls the operation of the management server 30. The management server 30 may be a personal computer (PC), for example.

The storage unit 34 stores the term registration database 34a. In the term registration database 34a, terms are registered with them bearing recognizability information corresponding to the respective terms. As has been described, the recognizability information is information indicative of each reader type to which readers capable of recognizing the respective registered terms belong and each reader type to which readers incapable of recognizing the respective registered terms belong.

The control unit 35 includes a CPU, a ROM that stores a program and various types of data, and a RAM used as a work area for the CPU, for example. The CPU executes a program stored in the ROM or the storage unit 34.

FIG. 4 shows an example of the term registration database 34a.

Four terms, “AAAAA”, “BBBBB”, “CCCCC”, and “DDDDD” are registered in the term registration database 34a shown in FIG. 4.

Four reader types of “manager”, “general user”, “in-house software engineer”, and “in-house hardware engineer” are registered (or set) in the term registration database 34a shown in FIG. 4. The “manager” means a manager of the MFP 20. The “general user” means general users of the MFP 20. The “in-house software engineer” means employees of a software-related technical division in the company that owns the MFP 20. The “in-house hardware engineer” means employees of a hardware-related technical division in the company that owns the MFP 20.

The word “RECOGNIZABLE” in FIG. 4 means that a term is recognizable. According to the term registration database 34a shown in FIG. 4, the term “AAAA” is recognizable to readers belonging to the reader types of “in-house software engineer” and “in-house hardware engineer”. The term “BBBB” is recognizable to readers belonging to the reader types of “manager”, “in-house software engineer”, and “in-house hardware engineer”. The term “CCCCC” is recognizable to readers belonging to the reader type of “in-house hardware engineer”. The term “DDDDD” is recognizable to readers belonging to the reader type of “in-house software engineer”.

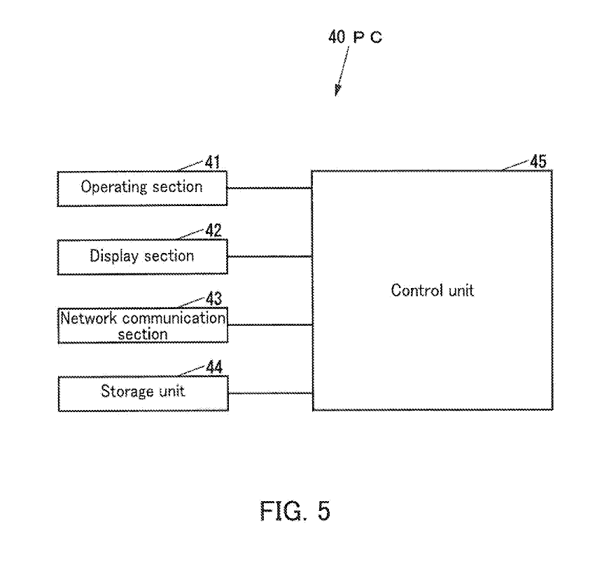

FIG. 5 shows a configuration of the PC 40.

As shown in FIG. 5, the PC 40 includes an operating section 41, a display section 42, a network communication section 43, a storage unit 44, and a control unit 44. The operating section 41 may be an input device, such as a mouse, a keyboard, or the like. The user can manipulate the operating section 41 to cause the PC 40 to execute various processing. The display section 42 is a device that displays a variety of information. The display section 42 may be a liquid crystal display (LCD) or the like, for example. The network communication section 43 may be a device that communicates with an external device (electronic device) via the network 11 (see FIG. 1). The storage unit 44 may be a device that stores a program and various types of data. A nonvolatile memory, such as a HDD may be used as the storage unit 44. The control unit 45 may be a processor that controls the operation of the PC 40.

The control unit 45 includes a CPU, a ROM that stores a program and various types of data, and a RAM used as a work area for the CPU, for example. The CPU executes a program stored in the ROM or the storage unit 44.

An operation of the document processing system 10 will be described next.

Description will be made first about an operation of the MFP 20 when a user registers a term.

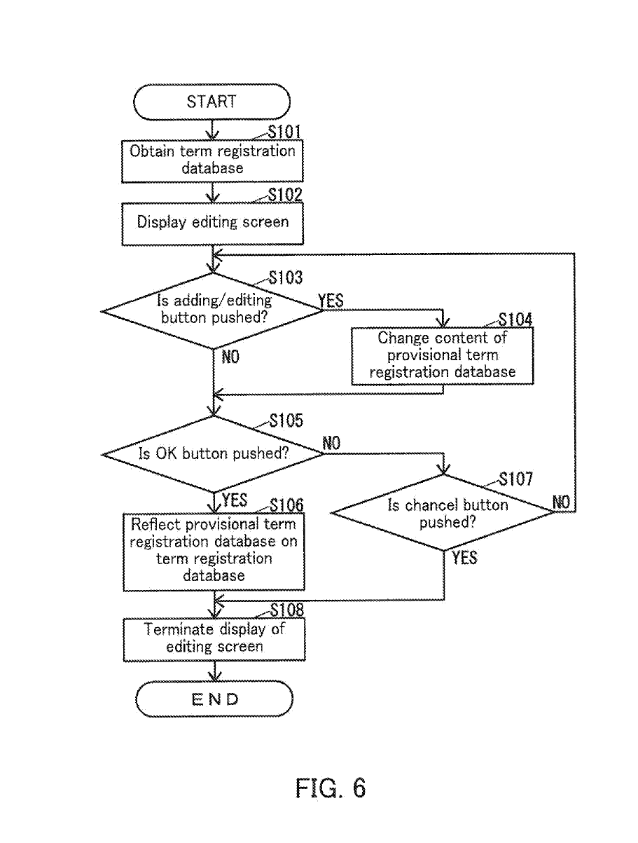

When the user manipulates the operating section 21 to cause the MFP 20 to start processing for term registration, the control unit 28 of the MFP 20 executes the process shown in FIG. 6.

FIG. 6 depicts an operation of the MFP 20 when the user registers a term.

As shown in FIG. 6, the term registering section 28a of the control unit 28 obtains the term registration database 34a stored in the management server 30 from the management server 30 via the network communication section 26 (S101). Hereinafter, the term registration database 34a obtained in S101 is referred to as a provisional term registration database.

Next, the term registering section 28a causes the display section 22 to display an editing screen 50 based on the content of the provisional term registration database, that is, each registered term and corresponding recognizability information that the registered term bears (S102).

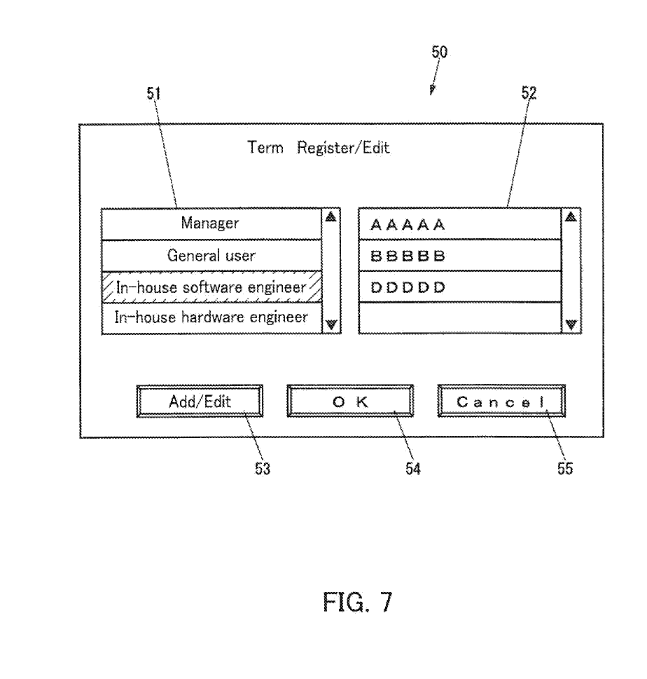

FIG. 7 shows an example of the editing screen 50.

As shown in FIG. 7, the editing screen 50 includes a list box 51 indicative of a reader type, a list box 52 indicative of a term, an adding/editing button 53, an OK button 54, and a cancel button 55. The adding/editing button 53 is a component for changing the content of the provisional term registration database. The OK button 54 is a component for reflecting the provisional term registration database on the term registration database 34a stored in the management server 30. The cancel button 55 is a component for suspending content change in the provisional term registration database.

The item indicated in the list box 51, “Manager” corresponds to the reader type of “manager”. The item, “General user” corresponds to the reader type of “general user”. The item, “In-house software engineer” corresponds to the reader type of “in-house software engineer”. The item, “In-house hardware engineer” corresponds to the reader type of “in-house hardware engineer”.

Among the terms registered in the provisional term registration database, each term that is recognizable to readers belonging to a reader type corresponding to an item (highlighted or reversed item) selected in the list box 51 is displayed in the list box 52.

As shown in FIG. 6, the term registering section 28a determines whether or not the adding/editing button 53 is pushed through the operating section 21 after S102 (S103).

Upon determination that the adding/editing button 53 is pushed (YES in S103), the term registering section 28a changes the content of the provisional term registration database according to user's manipulation on the operating section 21 (S104). Specifically, the term registering section 28a can execute addition, change, and deletion of a reader type on the provisional term registration database according to user's manipulation on the operating section 21. Further, the term registering section 28a can execute addition, change, and deletion of a term on the provisional term registration database on a reader type basis according to user's manipulation on the operating section 21.

Upon determination that the adding/editing button 53 is not pushed (NO in S103) or after execution of S104, the term registering section 28a determines whether or not the OK button 54 is pushed through the operating section 21 (S105).

When it is determined that the OK button 54 is pushed (YES in S105), the term registering section 28a reflects the content of the provisional term registration database on the term registration database 34a in the management server 30 (S106). In other words, the term registering section 28a transmits the provisional term registration database to the management server 30 via the network communication section 26 to cause the management server 30 to update the term registration database 34a.

When it is determined that the OK button 54 is not pushed (NO in S105), the term registering section 28a determines whether or not the cancel button 55 is pushed through the operating section 21 (S107).

When it is determined that the cancel button 55 is not pushed (NO in S107), the process of the control unit 28 returns to S103.

When S106 is executed or it is determined that the cancel button 55 is pushed (YES in S107), the term registering section 28a causes termination of display of the editing screen 50 (S108). Then, the MFP 20 terminates the operation shown in FIG. 6.

Description will be made next about an operation of the MFP 20 when a user sets a reference reader type.

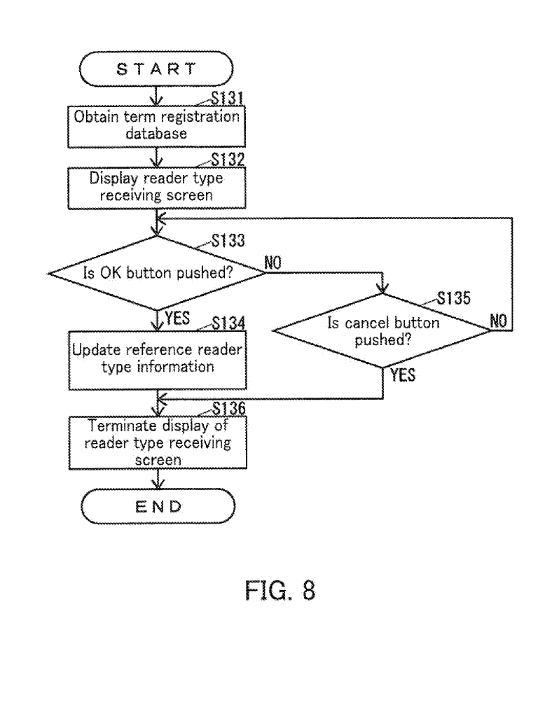

When the user manipulates the operating section 21 to cause the MFP 20 to start processing for reference reader type setting, the control unit 28 of the MFP 20 executes the process shown in FIG. 8.

FIG. 8 depicts an operation of the MFP 20 when the user sets a reference reader type.

As shown in FIG. 8, the reader type receiving section 28b of the control unit 28 obtains the term registration database 34a stored in the management server 30 from the management server 30 via the network communication section 26 (S131).

Next, the reader type receiving section 28b causes the display section 22 to display a reader type receiving screen 60 based on the content of the term registration database 34a obtained in S131, that is, based on information on each reader type registered (or set) in the term registration database 34a.

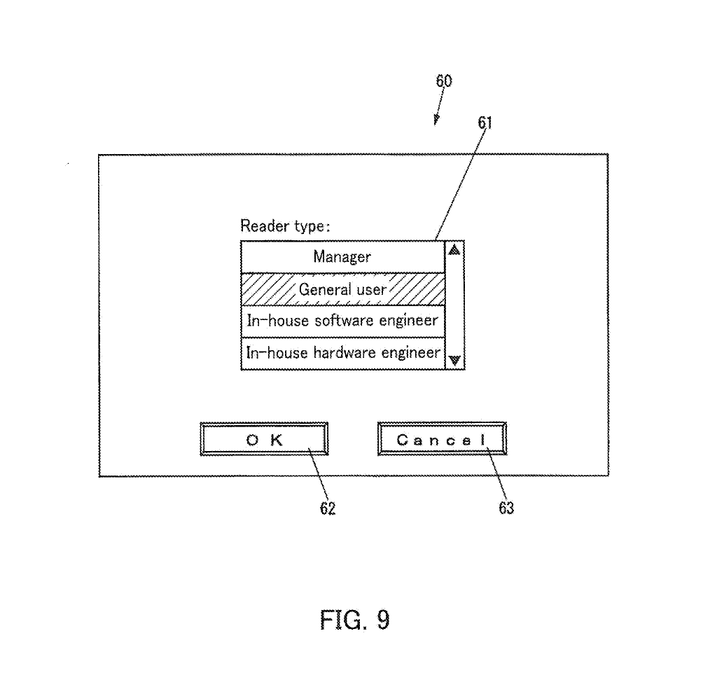

FIG. 9 shows an example of the reader type receiving screen 60.

As shown in FIG. 9, the reader type receiving screen 60 includes a list box 61 indicative of each reader type, an OK button 62, and a cancel button 63. The OK button 62 is a component for setting a reader type. The cancel button 63 is a component for suspending reader type setting.

The list box 61 is similar to the list box 51 shown in FIG. 7.

As shown in FIG. 8, the reader type receiving section 28b determines whether or not the OK button 62 is pushed through the operating section 21 (S133).

When it is determined that the OK button 62 is pushed (YES in S133), the reader type receiving section 278b updates the reference reader type information 27b to information indicative of a reader type selected in the list box 61 (S134).

When it is determined that the OK button 62 is not pushed (NO in S133), the reader type receiving section 28b determines whether or not the cancel button 63 is pushed through the operating section 21 (S135).

When it is determined that the cancel button 63 is not pushed (NO in S135), the process of the control unit 28 returns to S133.

When S134 is executed or it is determined that the cancel button 63 is pushed (YES in S135), the reader type receiving section 28b causes termination of display of the reader type receiving screen 60 (S136). Then, the MFP 20 terminates the operation shown in FIG. 8.

An operation of the MFP 20 in document output by itself will be described next.

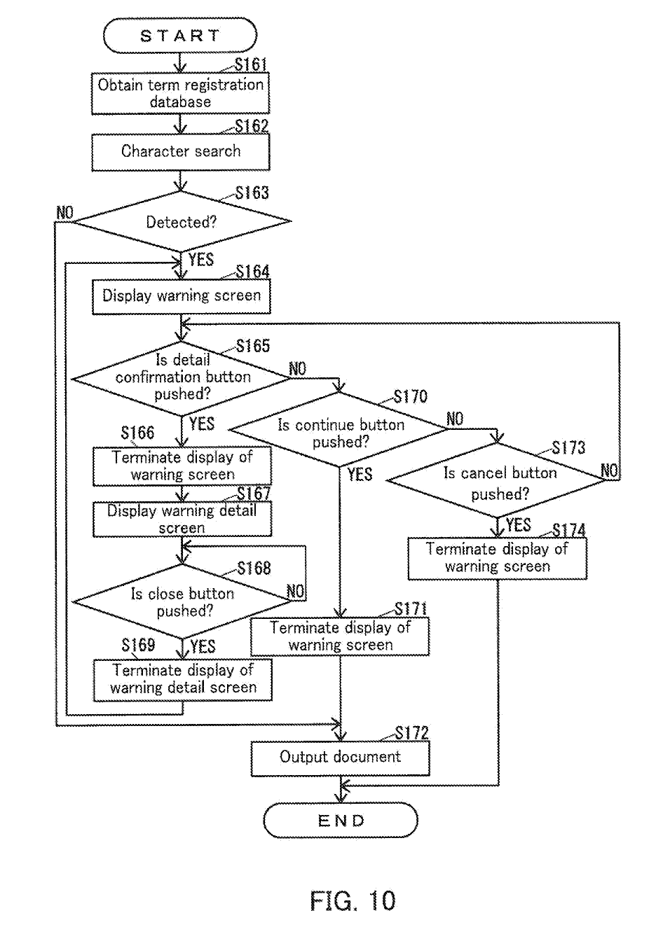

Upon input of an instruction for document output, the control unit 28 of the MFP 20 executes the process shown in FIG. 10. In the embodiment, document output may include the following processes, for example: printing an image on a recording medium by the printer 24 based on data of an image read from an original document by the scanner 23; printing an image on a recording medium by the printer 24 based on print data transmitted from the PC 40; transmitting data on an image read from an original document by the scanner 23 to an external facsimile device by the facsimile communication section 25; transmitting facsimile data transmitted from the PC 40 to an external facsimile device by the facsimile communication section 25; and transmitting data on an image read from an original document by the scanner 23 to an external device (electronic device) by the network communication section 26. Document output may be instructed from the operating section 21, for example. Alternatively, document output is instructed from the PC 40 via the network communication section 26, for example.

FIG. 10 depicts an operation of the MFP 20 in document output by itself.

As shown in FIG. 10, the term detecting section 28c of the control unit 28 obtains the term registration database 34a stored in the management server 30 from the management server 30 via the network communication section 26 (S161).

Next, the term detecting section 28c performs character search throughout an entire output target document for any term non-recognizable to readers belonging to the reader type that the reference reader type information 27b indicates (S162). The term detecting section 28c selects the term as a search target based on the reference reader type information 27b and the content of the term registration database 34a obtained in S161, that is, registered terms and corresponding recognizability information that the respective registered terms bear. Where the output target document is an image, the term detecting section 28c extracts character information from the image with the use of an optical character reader (OCR) and executes character search for the term on the extracted character information.

Subsequently, the term detecting section 28c determines whether or not the search target term is detected from the output target document in S162 (S163).

Upon detection of the search target term (YES in S163), the warning section 28d causes the display section 22 to display the warning screen 70 (S164). This means issuance of a warning. Where it is the PC 40 that instructs document output, the warning section 28d transmits information indicative of the content of the warning screen 70 to the PC 40 via the network communication section 26, thereby causing the display section 42 of the PC 40 to display the warning screen 70.

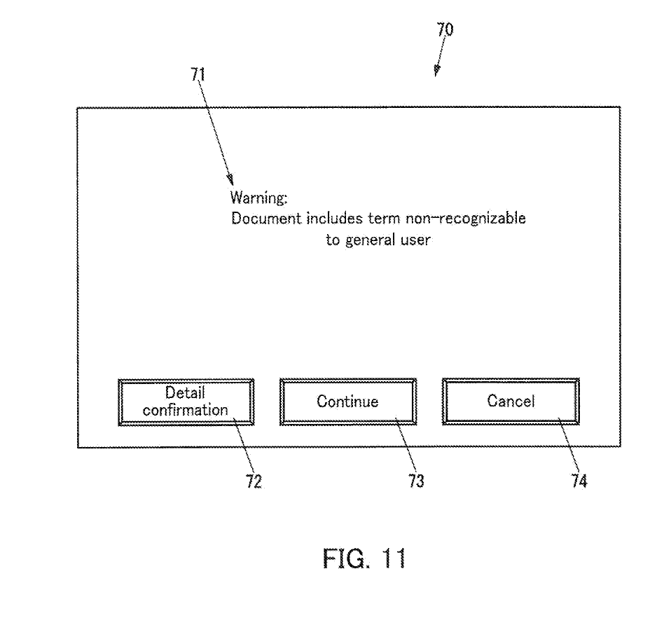

FIG. 11 shows an example of the warning screen 70.

The warning screen 70 shown in FIG. 11 includes a message 71 indicative of a warning content, a detail confirmation button 72, a continue button 73, and a cancel button 74. The detail confirmation button 72 is a button for confirming details of the warning content. The continue button 73 is a button for causing continuation of document output. The cancel button 74 is a button for suspending document output.

The message 71 shown in FIG. 11 is an example of messages displayed when the reader type that the reference reader type information 27b indicates is the “general user” and an output target document includes a term non-recognizable to a reader belonging to the reader type of the “general user” among the terms registered in the term registration database 34a.

As shown in FIG. 10, the warning section 28d determines whether or not the detail confirmation button 72 is pushed through the operating section 21 after S164 (S165). It is noted that where it is the PC 40 that instructs document output, the warning section 28d receives the instruction through the operating section 41 of the PC 40 via the network communication section 26 and executes the processing in S165 according to the received instruction.

When it is determined that the detail confirmation button 72 is pushed (YES in S165), the warning section 28d causes termination of display of the warning screen 70 (S166).

Subsequently, the term notifying section 28e causes the display section 22 to display a warning detail screen 80 based on the term detected in S163 and the content of the term registration database 34a, that is, the registered terms and corresponding recognizability information that the respective registered terms bear (S167). It is noted that where it is the PC 40 that instructs the document output, the term notifying section 28e transmits the information indicative of the content of the warning detail screen 80 to the PC 40 via the network communication section 26 to cause the display section 42 of the PC 40 to display the warning detail screen 80.

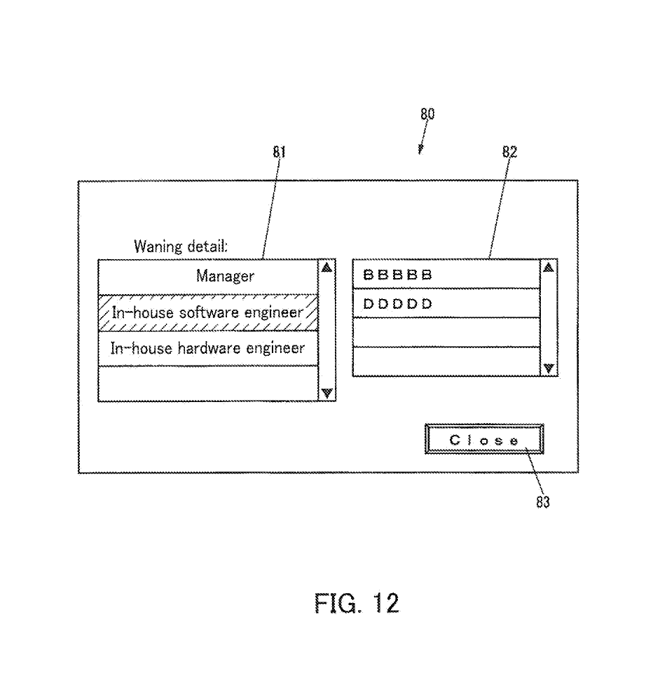

FIG. 12 shows an example of the warning detail screen 80.

The warning detail screen 80 shown in FIG. 12 includes a list box 81 indicative of a reader type, a list box 82 indicative of a term, and a close button 83. The close button 83 is a component for closing the warning detail screen 80.

The list box 81 indicates only an item corresponding to any reader type to which readers capable of recognizing at least one of the term(s) detected in S162 belong among the reader types registered (or set) in the term registration database 34a.

The list box 82 indicates each term recognizable to readers belonging to the reader type corresponding to an item (highlighted or reversed item) selected in the list box 81 among the terms detected in S162.

The warning detail screen 80 is a screen to notify each term detected from the output target document. Accordingly, the term notifying section 28e causes the warning detail screen 80 to be displayed, thereby notifying the term detected from the output target document in S162.

As shown in FIG. 10, the term notifying section 28e determines whether or not the close button 83 is pushed until it is determined that the close button 83 is pushed through the operating section 21 after S167 (S168). Where it is the PC 40 that instructs document output, the term notifying section 28e receives the instruction through the operating section 41 of the PC via the network communication section 26 and then executes the processing in S168 according to the received instruction.

When it is determined that the close button 83 is pushed (YES in S168), the term notifying section 28e causes termination of display of the warning detail screen 80 (S169).

Thereafter, the process of the control unit 28 returns to S164.

Upon determination that the detail confirmation button 72 is not pushed yet (NO in S165), the warning section 28d determines whether or not the continue button 73 is pushed through the operating section 21 (S170). It is noted that where it is the PC 40 that instructs the document output, the warning section 28d receives the instruction through the operating section 41 of the PC 40 via the network communication section 26 and executes the processing in S170 according to the received instruction.

When it is determined that the continue button 73 is pushed (YES in S170), the warning section 28d causes termination of display of the warning screen 70 (S171).

When it is determined that no search target term is detected from the output target document (NO in S163) or the processing in S171 is terminated, the document output section 28f controls the operation of the MFP 20 so that the output target document is output (S172). Then, the MFP 20 terminates the operation shown in FIG. 10. Herein, the document output section 28f controls the operation of the MFP 20 for execution of any one of: printing of the output target document by the printer 24; facsimile transmission of the output target document by the fax communication section 25; and transmission of the output target document by the network communication section 26, according to the instructed output method.

Upon determination that the continue button 73 is not pushed (NO in S170), the warning section 28d determines whether or not the cancel button 74 is pushed through the operating section 21 (S173). It is noted that where it is the PC 40 that instructs document output, the warning section 28d receives the instruction through the operating section 41 of the PC 40 via the network communication section 26 and executes the processing in S173 according to the received instruction.

When it is determined that the cancel button 74 is not pushed (NO in S173), the process of the control unit 28 returns to S165.

When it is determined that the cancel button 74 is pushed (YES in S173), the warning section 28d causes termination of display of the warning screen 70 (S174). Then, the MFP 20 terminates the operation shown in FIG. 10.

As has been described so far, when any term non-recognizable to readers belonging to a specified reader type among the registered terms is detected from a document (YES in S163), the MFP 20 issues a warning (S164). This can achieve appropriate issuance of a warning when the document includes any term non-recognizable to the readers, such as a technical term, a coined word, an in-house word, etc.

In particular, when any term non-recognizable to readers belonging to a specified reader type among the registered terms is detected from a document, the MFP 20 automatically issues a warning. This can increase detection accuracy when compared with a method in which a person reads the document to confirm whether or not the document includes any term non-recognizable to the readers belonging to the specified reader type.

Further, the MFP 20 performs character search throughout an entire document for any term non-recognizable to readers belonging to a specified reader type among the registered terms. Accordingly, term detection can be performed regardless of the types of documents. This can increase versatility when compared with a configuration that can cope with only documents of a specific type.

When any term non-recognizable to readers belonging to a specified reader type among the registered term is detected from a document, the MFP 20 notifies the detected term (S167). This can allow the user (reader) to confirm the term non-recognizable to the readers in the document.

When any term non-recognizable to readers belonging to a specified reader type among the registered term is detected from a document, the MFP 20 notifies a reader type to which readers capable of recognizing the detected term belong (S167). Accordingly, the user can be notified of each reader type of readers capable of recognizing the detected term.

When no term non-recognizable to readers belonging to a specified reader type among the registered terms is detected from a document, the MFP 20 outputs the document (NO in S163 and S172). By contrast, when any term non-recognizable to readers belonging to the specified reader type among the registered terms is detected from the document, the MFP 20 suspends output of the document (YES in S163 and S164). This can prevent a document including a term non-recognizable to the readers from being output.

It is noted that the management server 30 stores the term registration database 34a in the document processing system 10 according to the present embodiment, but the MFP 20 may store the term registration database 34a.

The document processing system 10 according to the present embodiment receives an instruction through the operating section 21 of MFP 20 and displays the information on the display section 22 of the MFP 20 in term registration, as shown in FIG. 6. Alternatively, the document processing system 10 may receive an instruction through the operating section 31 of the management server 30 and display the information on the display section 32 of the management server 30 in term registration. Similarly, the document processing system 10 may receive an instruction through the operating section 41 of the PC 40 and display the information on the display section 42 of the PC 40 in term registration.

The MFP 20 stores the reference reader type information 27b in the document processing system 10 according to the present embodiment. Alternatively, the management server 30 may store the reference reader type information 27b.

The document processing system 10 according to the present embodiment receives an instruction through the operating section 21 of MFP 20 and displays the information on the display section 22 of the MFP 20 in reference reader type setting, as shown in FIG. 8. Alternatively, the document processing system 10 may receive an instruction through the operating section 31 of the management server 30 and display the information on the display section 32 of the management server 30 in reference reader type setting. Similarly, the document processing system 10 may receive an instruction through the operating section 41 of the PC 40 and display the information on the display section 42 of the PC 40 in reference reader type setting.

The control unit 28 of the MFP 20 executes the document processing program 27a to function as the term registering section 28a, the reader type receiving section 28b, the term detecting section 28c, the warning section 28d, the term notifying section 28e, and the document output section 28f in the document processing system 10 according to the present embodiment. Alternatively, the control unit of any device (electronic device) other than the MFP 20, such as the management server 30 may function as at least one of the term registering section, the reader type receiving section, the term detecting section, the warning section, the term notifying section, and the document output section.

The document processing device of the present disclosure is a MFP in the present embodiment, but may be any image forming apparatus other than the MFP, such as an apparatus dedicated for printing, copying, faxing, or the like, or may be any electronic device other than such an image forming apparatus.

What is claimed is:

1. A non-transitory computer readable recording medium that stores a document processing program to be executed by a computer,
the document processing program comprising:
a first program code configured to cause the computer to register a term with it bearing corresponding recognizability information indicative of a reader type to which readers capable of recognizing the term belong and a reader type to which readers incapable of recognizing the term belong;
a second program code configured to cause the computer to receive specification of a reader type to which a reader belongs;
a third program code configured to cause the computer to detect any term non-recognizable to the readers belonging to the reader type based on the specification from an output target document based on the recognizability information; and
a fourth program code configured to cause the computer to issue a warning when the term is detected through the third program code.

2. A recording medium according to claim 1, wherein
the document processing program further comprising a fifth program code configured to cause the computer to notify the term detected through the third program code.

3. A recording medium according to claim 1, wherein
the document processing program further comprising a sixth program code configured to cause the computer to notify any reader type to which the readers capable of recognizing the term detected through the third program cord belong based on the recognizability information.

4. A recording medium according to claim 1, wherein
the document processing program further comprising:
a seventh program code configured to cause the computer to output the output target document when no term non-recognizable to the readers belonging to the reader type based on the specification is detected from the output target document; and
an eighth program code configured to cause the computer to suspend output of the output target document when any term non-recognizable to the readers belonging to the reader type based on the specification is detected from the output target document.

5. A document processing device comprising:
a term registering section configured to register a term with it bearing corresponding recognizability information indicative of a reader type to which readers capable of recognizing the term belong and a reader type to which readers incapable of recognizing the term belong;
a reader type receiving section configured to receive specification of a reader type to which a reader belongs;
a term detecting section configured to detect any term non-recognizable to the readers belonging to the reader type based on the specification from an output target document based on the recognizability information; and
a warning section configured to issue a warning when the term detecting section detects the term.

6. A document processing device according to claim 5, further comprising:
a term notifying section configured to notify the term that the term detecting section detects.

7. A document processing device according to claim 5, further comprising:
a term notifying section configured to notify any reader type to which the readers capable of recognizing the term detected by the term detecting section belong based on the recognizability information.

8. A document processing device according to claim 5, further comprising:
a document output section configured to execute:
output of the output target document when no term non-recognizable to the readers belonging to the reader type based on the specification is detected from the output target document; and
suspension of output of the output target document when any term non-recognizable to the readers belonging to the reader type based on the specification is detected from the output target document.

9. A document processing system comprising:
a document processing device configured to output a document;
an electronic device connected to the document processing device through a network;
a term registering section configured to execute processing for registering a term with it bearing corresponding recognizability information indicative of a reader type to which readers capable of recognizing the term belong and a reader type to which readers incapable of recognizing the term belong;
a reader type receiving section configured to execute processing for receiving specification of a reader type to which a reader belongs.
a term detecting section configured to execute processing for detecting any term non-recognizable to the readers belonging to the reader type based on the specification from an output target document based on the recognizability information; and
a warning section configured to execute processing for issuing a warning when the term detecting section detects the term,
wherein the term registering section, the reader type receiving section, the term detecting section, and the warning section are provided on one of the document processing device and the electronic device, or are provided on the document processing device and the electronic device in a distributed manner.

10. A document processing system according to claim 9, further comprising:
a term notifying section provided on the document processing device or the electronic device and configured to execute processing for notifying the term that the term detecting section detects.

11. A document processing system according to claim 9, further comprising:
a term notifying section provided on the document processing device or the electronic device and configured to perform processing for notifying any reader type to which the readers capable of recognizing the term detected by the term detecting section belong based on the recognizability information.

12. A document processing system according to claim 9, further comprising:
a document output section provided on the document processing device or the electronic device,
wherein the document output section executes:
processing for outputting the output target document when no term non-recognizable to the readers belonging to the reader type based on the specification is detected from the output target document; and
processing for suspending output of the output target document when any term non-recognizable to the readers belonging to the reader type based on the specification is detected from the output target document.
